(19) United States
(12) Patent Application Publication
(10) Pub. No.: US 2026/0309256 A1
(43) Pub. Date: Oct. 8, 2026

(54) CONNECTING SYSTEM AND PRESSING TOOL FOR A CONNECTING SYSTEM

(71) Applicant: Henn GmbH & Co KG., Dornbirn (AT)

(72) Inventor: Marvin RIST, Kennelbach (AT)

(73) Assignee: Henn GmbH & Co KG., Dornbirn (AT)

(21) Appl. No.: 19/482,932

(22) PCT Filed: May 14, 2024
(86) PCT No.: PCT/AT2024/060206

§ 371 Date: Nov. 10, 2025

(30) Foreign Application Priority Data
May 17, 2023 (AT) A50389/2023

(51) Int. Cl. F16L 13/14; B21J 13/04; F16L 33/207

(52) U.S. Cl. CPC F16L 13/143; B21J 13/04; F16L 33/2076; F16L 2013/145

(57) ABSTRACT

A connecting system for connecting first and second fluid lines has a connecting sleeve with open first and second connecting-sleeve ends. The first line is pushable onto a sleeve first connecting portion to connect the first line to the first end. The second end includes a second connecting portion for connecting to the second line. The first connecting portion includes a cylindrical receiving portion. Circumferentially-spaced retaining protrusions each extending at least along part of the receiving portion length are on a receiving portion outer circumferential surface. The connecting system also includes a ferrule arrangeable on the sleeve to surround the receiving portion and, in radial direction between the receiving portion and a ferrule inner circumferential surface, a receiving space for receiving a first line end portion is configured. In the circumferential direction, in each case between two retaining protrusions, the ferrule is plastically deformable radially by a pressing tool.

The invention relates to a connecting system for connecting a first fluid line to a second fluid line, wherein the connecting system has a connecting sleeve with an open first connecting-sleeve end and an open second connecting-sleeve end connected to the first connecting sleeve end, wherein a first connecting portion is provided on the connecting sleeve, onto which the first fluid line can be pushed in order to connect the first fluid line to the first connecting-sleeve end of the connecting sleeve, and wherein the second connecting-sleeve end comprises a second connecting portion for connecting to the second fluid line. Furthermore, the invention relates to a use of the connecting system and a pressing tool for carrying out a connecting process with the connecting system.

Generic connecting systems are used in a wide range of industrial applications to connect fluid-carrying components. A connecting sleeve is usually provided for this purpose, which can be connected at one end to a first fluid line, preferably a plastic pipe. At the opposite end, the connecting sleeve can be connected to a second fluid line, e.g. another plastic pipe, for example using a suitable plug connector or a suitable coupling. The connection to the first fluid line is usually fixed, i.e. it cannot be released once the connection has been established. The connection to the other fluid line can be fixed or detachable, depending on the specific application.

Various configurations are known for connecting the first fluid line to the connecting sleeve. WO 2013/189740A2, for example, shows a generic connecting system in which the connection to the first fluid line is made by means of a clamping sleeve that can be elastically deformed in portions.

One object of the present invention was to provide a connecting system that is simple in design, can be produced at low cost and enables a reliable connection even with relatively low-quality pipelines. Another task was to provide a suitable tool for carrying out a connecting process with the connecting system.

The object is solved with the above-mentioned connecting system in that the first connecting portion of the connecting sleeve comprises a cylindrical receiving portion, wherein a plurality of retaining protrusions spaced apart in the circumferential direction are provided on an outer circumferential surface of the receiving portion, each of which projections extends over at least part of a length of the receiving portion, and in that the connecting system comprises a ferrule, wherein the ferrule can be arranged on the connecting sleeve such that it surrounds the receiving portion and that a receiving space for receiving an end portion of the first fluid line is formed in the radial direction between the receiving portion and an inner circumferential surface of the ferrule, wherein the ferrule is configured to be plastically deformed in the circumferential direction in each case in the region between two retaining protrusions by a pressing tool in the radial direction in order to fix the first fluid line to the first connecting portion in a twistproof manner. The fact that the ferrule can be plastically deformed in portions in the circumferential direction means that an anti-torsion lock can be achieved by the plastically deformed deformation regions of the ferrule co-operating with the retaining protrusions of the connecting sleeve in an essentially positive locking manner.

Preferably, at least one of the retaining protrusions of the connecting sleeve has an elongated configuration and extends over at least half the length of the receiving portion. Alternatively or additionally, it is advantageous if the plurality of retaining protrusions comprises at least two, preferably at least four, particularly preferably at least six, especially at least eight retaining protrusions. It may also be advantageous if the retaining protrusions are evenly distributed on the receiving portion in the circumferential direction. This results in an improved anti-torsion protection because the ferrule can co-operate with the retaining protrusions over a greater length.

Preferably, a circumferential groove is provided between the receiving portion and the first connecting-sleeve end of the connecting sleeve, in which a gasket, preferably an O-ring or a moulded seal, can be arranged or is arranged. This allows an improved seal to be achieved between the connecting sleeve and the first fluid line.

A centring portion for centring the first fluid line may be provided at the first connecting-sleeve end of the connecting sleeve. This makes it easier pushing on the first fluid line.

Between the receiving portion and the first connecting-sleeve end of the connecting sleeve, a preferably conical or curved extension portion tapering in the direction of the first connecting-sleeve end may be provided, wherein the extension portion is preferably arranged between the centring portion and the circumferential groove. As a result, the first fluid line can be widened when it is pushed on, allowing the first fluid line to fit snugly against the receiving portion.

Preferably, the connecting sleeve is made of plastic, wherein the retaining protrusions are configured integrally with the connecting sleeve. This enables a simple and cost-effective production.

A limiting portion may be provided between the receiving portion and the second connecting-sleeve end of the connecting sleeve, which forms a stop for the first fluid line. Preferably, the limiting portion comprises a circumferential shoulder with a first end face facing the first connecting-sleeve end and an opposite second end face facing the second connecting-sleeve end, wherein the retaining protrusions are preferably connected to the circumferential shoulder. This prevents the first fluid line from being pushed on too far and ensures correct positioning of the first fluid line.

The circumferential shoulder may comprise at least one fixing recess which extends in the circumferential direction over a part of the circumferential shoulder, connects the first end face to the second end face and is preferably open to the outside in the radial direction, and the ferrule may have at least one fixing lug at a ferrule end facing the second connecting-sleeve end, which, in the assembled state, extends through the at least one fixing recess of the circumferential shoulder in the direction of the second connecting-sleeve end and bears against the second end face of the circumferential shoulder. This enables a simple positive locking fixing of the ferrule so that the ferrule is held captive on the connecting sleeve.

A retaining groove for receiving a retaining tool may be provided between the limiting portion, in particular the circumferential shoulder and the second connecting-sleeve end of the connecting sleeve. This allows the connecting sleeve to be held in position while the first fluid line is being pushed on. This may be particularly advantageous when pushing on the extension portion.

It may be advantageous if the retaining groove comprises at least one web for holding the retaining tool in a twistproof manner. This prevents the connecting sleeve from twisting relative to the holding tool while the first fluid line is being pushed on.

The ferrule is preferably made of a metallic material, preferably aluminium. Suitable metals have good plastic deformability and high strength. In order to further improve the plastic deformability, the ferrule may have material weakenings in the deformation regions intended for deformation.

The connecting system according to the invention is preferably used in that a pipe, preferably made of plastic, is pushed onto the first connecting portion of the connecting sleeve until an end portion of the first fluid pipe is arranged in the receiving space and that the ferrule is plastically deformed in the circumferential direction in each case in the region between two retaining protrusions by a pressing tool in the radial direction in order to fix the first fluid pipe to the first connecting portion in a twistproof manner.

The object is further solved with the pressing tool mentioned at the beginning in that the pressing tool comprises an arrangement space for arranging the connecting system, in that the pressing tool has a plurality of pressing fingers which are arranged distributed in a circumferential direction around the arrangement space, and in that the pressing fingers are each configured to be moved in the direction of the arrangement space and to exert a pressing force in the radial direction on the ferrule of the connecting system arranged in the arrangement space, by means of which the ferrule can be plastically deformed in portions in the circumferential direction.

It is advantageous if the pressing tool comprises a guide sleeve which surrounds the arrangement space in the circumferential direction, wherein the guide sleeve is arranged such that the guide sleeve surrounds the ferrule of a connecting system arranged in the arrangement space, wherein a guide recess for guiding the respective pressing finger is provided on the guide sleeve for each pressing finger. This enables reliable guidance of the pressing fingers and prevents unwanted deformation of the ferrule. It is advantageous if the distance between an inner circumferential surface of the guide sleeve and an outer circumferential surface of the ferrule is as small as possible. For example, the guide sleeve could lie directly against the ferrule. The guide sleeve could also be interchangeable if necessary, so that a suitable guide sleeve can be arranged in the pressing tool depending on the diameter of the ferrule.

The pressing tool preferably comprises a force generation device for generating the pressing force and a control unit for controlling the force generation device. This allows the connecting process to be at least partially automated.

For a better understanding of the invention, it is explained in more detail with the aid of the following figures.

The figures show a simplified, schematic representation as follows:

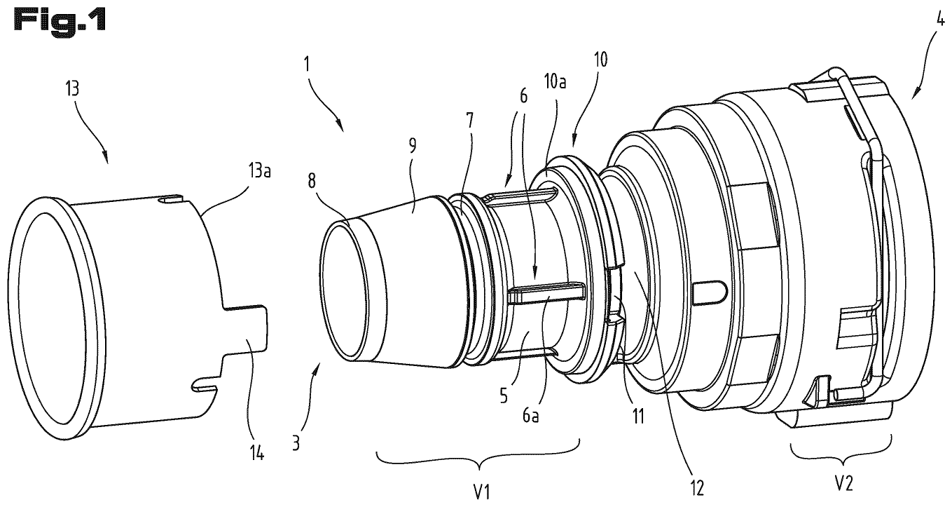

FIG. 1 an exploded view of a connecting system of an advantageous embodiment;

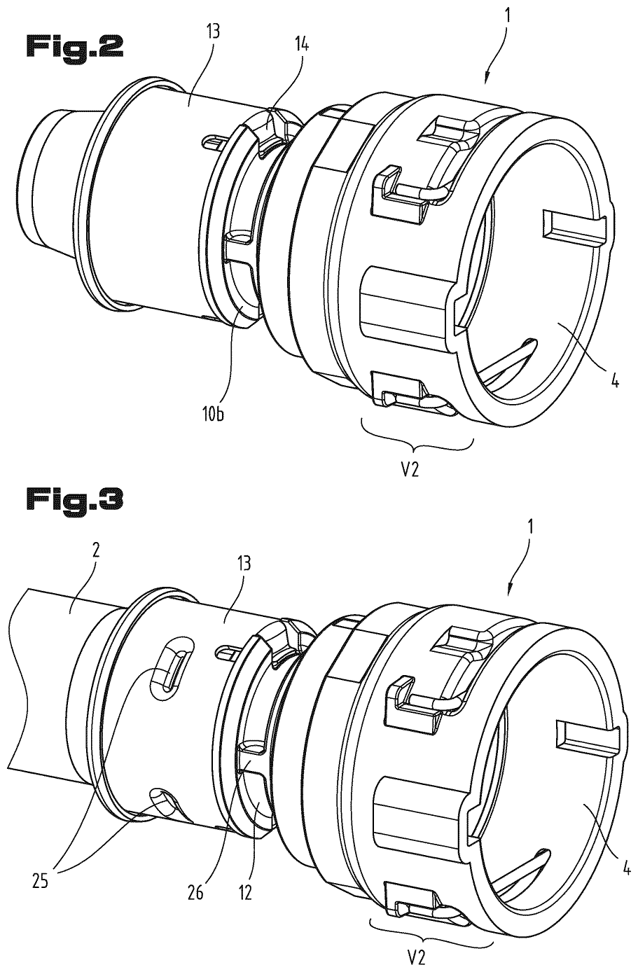

FIG. 2 a perspective view of the connecting system with assembled ferrule;

FIG. 3 a perspective view of the connecting system with a connected first fluid line;

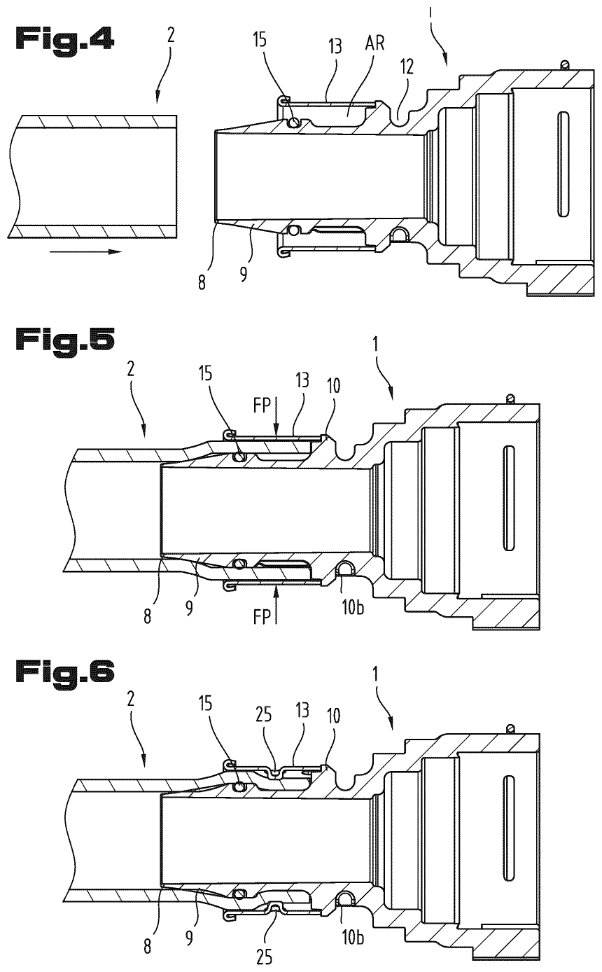

FIG. 4 a longitudinal section of the connecting system before the first fluid line is pushed on;

FIG. 5 a longitudinal section of the connecting system after the first fluid line has been pushed on;

FIG. 6 a longitudinal section of the connecting system with the first fluid line connected;

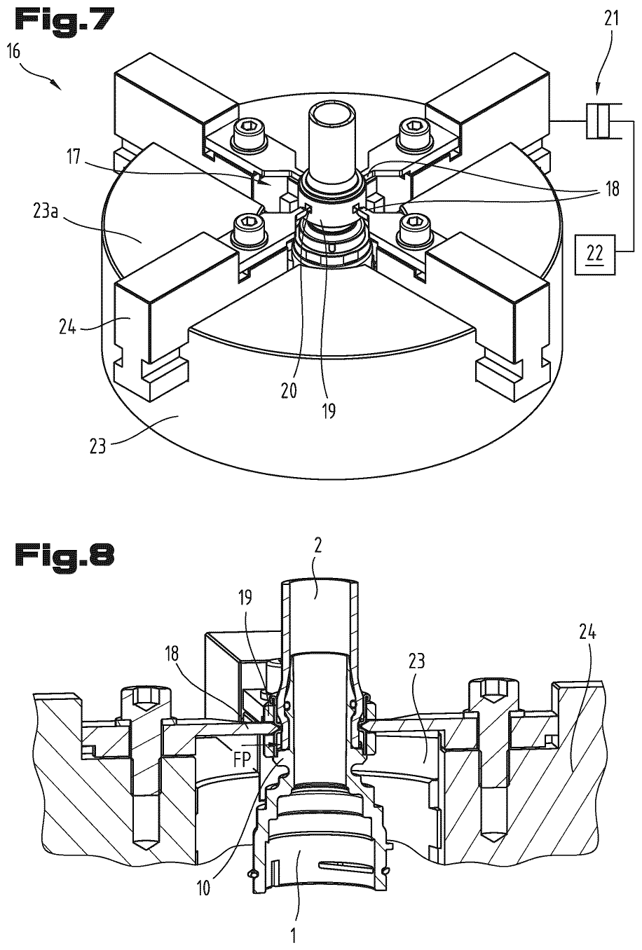

FIG. 7 a perspective view of a pressing tool for carrying out a connecting process with the connecting system;

FIG. 8 a sectional view of the pressing tool.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 shows an exploded view of a connecting system of an advantageous embodiment of the invention. The connecting system is configured to connect a first fluid line 2 to a second fluid line. The first fluid line 2 is shown in FIG. 3. For the sake of simplicity, the second fluid line is not shown in the figures.

The connecting system comprises a connecting sleeve 1 with an open first connecting-sleeve end 3 and an open second connecting-sleeve end 4. The first connecting-sleeve end 3 is connected to the second connecting-sleeve end 4 via a flow channel. A first connecting portion V1 is provided on the connecting sleeve 1, onto which the first fluid line 2 can be pushed in order to connect the first fluid line 2 to the first connecting-sleeve end 3 of the connecting sleeve 1. The connecting process is described in more detail later on in FIG. 4 to FIG. 6.

The second connecting-sleeve end 4 comprises a second connecting portion V2 for connecting to the second fluid line (not shown). In the embodiment shown, the second connecting portion V2 is configured to be connected to a known standardised plug-in sleeve in accordance with the VDA standard (VDA=German Association of the Automotive Industry). In this case, the plug-in sleeve forms the second fluid line. The plug-in sleeve can be detachably connected to the connecting sleeve 1. The plug-in sleeve can in turn be connected, for example permanently, to another fluid line. However, the illustrated configuration of the second connecting portion V2 is only to be understood as an example. The specific configuration of the second connecting portion V2 may vary depending on the second fluid line to be connected.

In the example shown, the connecting sleeve 1 has a straight configuration, wherein the first connecting-sleeve end 3 and the second connecting-sleeve end 4 are connected by means of a straight flow channel. In principle, however, the connecting sleeve 1 could also be curved, wherein the first connecting-sleeve end 3 and the second connecting-sleeve end 4 are arranged at a certain opening angle to each other and connected via a curved flow channel. The connecting sleeve 1 may also have an angled configuration, wherein the first connecting-sleeve end 3 and the second connecting-sleeve end 4 are arranged at a certain opening angle to each other. The flow channel may comprise two straight channel portions that are positioned at an opening angle to each other.

The first connecting portion V1 of the connecting sleeve 1 comprises a cylindrical receiving portion 5. Several retaining protrusions 6 are provided on an outer circumferential surface of the receiving portion 5, which are spaced apart from one another in the circumferential direction. The retaining protrusions 6 each extend over at least a part of a length of the receiving portion 5. The retaining protrusions 6 each project outwards in a radial direction from the outer circumferential surface of the receiving portion 5.

The retaining protrusions 6 may have an elongated configuration, for example, and preferably extend over at least half the length of the receiving portion 5, preferably over the entire length. The retaining protrusions 6 may each have a contact surface 6a that faces outwards in a radial direction. In the pushed-on state of the first fluid line 2, the contact surfaces 6a of the retaining protrusions 6 can contact an inner circumferential surface of the first fluid line 2. The contact surfaces 6a may be flat or they may also be rounded in the circumferential direction in order to better conform to the first fluid line 2.

In the context of the invention, the plurality of retaining protrusions 6 comprises at least two retaining protrusions 6. However, it may be advantageous if at least four, preferably at least six, in particular at least eight retaining protrusions 6 are provided. The illustrated embodiment of the connecting sleeve 1 comprises four retaining protrusions 6 as an example. The retaining protrusions 6 are preferably evenly distributed on the receiving portion 5 in the circumferential direction. Of course, an uneven distribution would also be conceivable in principle. If the connecting sleeve 1 is made of a suitable plastic, the retaining protrusions 6 may be configured integrally with the connecting sleeve 1 in an advantageous manner.

Furthermore, the connecting system comprises a ferrule 13, which may be arranged, preferably fixed, on the connecting sleeve 1. The ferrule 13 is shown in FIG. 1 in a non-assembled state and in FIG. 2 in an assembled state on the connecting sleeve 1. The ferrule 13 may be arranged on the connecting sleeve 1 such that it surrounds the receiving portion 5 and such that a receiving space AR for receiving an end portion of the first fluid line 2 is configured in the radial direction between the receiving portion 5 of the connecting sleeve 1 and an inner circumferential surface of the ferrule 13, as may be seen in FIG. 4. The ferrule 13 has a substantially cylindrical configuration. A length of the ferrule 13 is preferably at least the length of the receiving portion 5.

The ferrule 13 is configured to be plastically deformed in the circumferential direction in the region between two retaining protrusions 6 by a suitable pressing tool (not shown) in the radial direction in order to fix the first fluid line 2 to the first connecting portion V1 in a twistproof manner. A pressing tool of an advantageous embodiment will be described in more detail later with reference to FIG. 7 and FIG. 8. FIG. 3 shows the connecting system with a first fluid line 2 connected. The deformation regions 25 at which the ferrule 13 was plastically deformed by the pressing tool are shown in FIG. 3.

The ferrule 13 is preferably made of a sufficiently deformable metallic material with sufficiently high strength, for example aluminium. If necessary, the ferrule 13 could also have a material weakening in the area of the deformation regions 25 in order to improve the plastic deformability.

An advantageous use of the connecting system for connecting the first fluid line 2 is described with reference to FIGS. 4 to 6. Firstly, the first fluid line 2, preferably a plastic pipe, can be pushed onto the first connecting portion V1 of the connecting sleeve 1 via the first connecting-sleeve end 3, as indicated by the corresponding arrow in FIG. 4. A centring portion 8 for centring the first fluid line 2 may be provided at the first connecting-sleeve end 3 of the connecting sleeve 1 to make it easier to push it on. The centring portion 8 can also be seen in FIG. 1. The first fluid line 2 can be pushed on until an end portion of the first fluid line 2 is received in the receiving space AR formed between the ferrule 13 and the receiving portion 5 and the ferrule 13 surrounds the end portion of the first fluid line 2, as may be seen in FIG. 5.

In order to facilitate a correct positioning of the first fluid line 2, a limiting portion may be provided between the receiving portion 5 and the second connecting-sleeve end 4 of the connecting sleeve 1, which forms a stop for the first fluid line 2. The limiting portion may, for example, comprise a circumferential shoulder 10 with a first end face 10a facing the first connecting-sleeve end 3 (see FIG. 1) and an opposite second end face 10b facing the second connecting-sleeve end 4 (see FIG. 2, FIG. 4 and FIG. 5). In this case, the first fluid line 2 can be pushed onto the first connecting portion V1 until a front side of the first fluid line 2 facing the second connecting-sleeve end 4 is in contact with the first end face 10a of the circumferential shoulder 10. For greater stability, the retaining protrusions 6 may be connected to the circumferential shoulder 10 in the direction of the second connecting-sleeve end 4, as may also be seen in FIG. 1.

One or more fixing recesses 11 may also be provided on the circumferential shoulder 10 for fixing the ferrule 13. The fixing recesses 11 each extend in the circumferential direction over a part of the circumferential shoulder 10 and each connect the first end face 10a of the circumferential shoulder 10 with the second end face 10b. The fixing recesses 11 may also be open to the outside in a radial direction, as may be seen in FIG. 1. This may be advantageous to facilitate the assembly. In principle, however, the fixing recesses 11 could also have a closed circumference and thus be limited radially outwards by the circumferential shoulder 10.

The ferrule 13 may have one or more deformable fixing lugs 14 on one ferrule end 13a facing the second connecting-sleeve end 4, as shown in FIG. 1. The ferrule 13 may be fixed to the connecting sleeve 1 in that the fixing lugs 14 each extend through a fixing recess 11 of the circumferential shoulder 10 in the direction of the second connecting-sleeve end 4 and rest against the second end face 10b of the circumferential shoulder 10. This may be seen in FIG. 2 and FIG. 3. The number of fixing lugs 14 may be at least two, preferably at least four, for example. The fixing lugs 14 may, for example, be evenly distributed on the ferrule 13 in the circumferential direction. The number of fixing lugs 14 may, for example, correspond to the number of fixing recesses 11 in the circumferential shoulder 10.

The ferrule 13 may be pre-assembled on the connecting sleeve 1, for example. For this purpose, the ferrule 13 may be pushed onto the first connecting portion V1 with undeformed fixing lugs 14 (see FIG. 1), i.e. running parallel to an axis of the ferrule 13, until the ferrule end 13a of the ferrule 13 facing the second connecting-sleeve end 4 rests against the first end face 10a of the circumferential shoulder 10. The undeformed fixing lugs 14 each extend parallel to a centre axis of the connecting sleeve 1 through the fixing recesses 11. Finally, the fixing lugs 14 may be bent inwards until end portions of the fixing lugs 14 rest against the second end face 10b of the circumferential shoulder 10, as may be seen in FIG. 2 and FIG. 3. This allows the ferrule 13 to be fixed to the connecting sleeve 1 in a positive locking and essentially captive manner. For example, a suitable tool (not shown) may be used to deform the fixing lugs 14.

Between the receiving portion 5 and the first connecting-sleeve end 3 of the connecting sleeve 1, a preferably conical or curved extension portion 9 tapering in the direction of the first connecting-sleeve end 3 may be provided (see FIG. 1 and FIG. 4). The first fluid line 2 can be pushed onto the receiving portion 5 via the extension portion 9. As a result, the first fluid line 2 is widened and rests very snuggly against the receiving portion 5, in particular on the contact surfaces 6a of the retaining protrusions 6. The first fluid line 2 should of course have sufficient plastic or elastic deformability for this purpose. “Curved” can mean that the outer circumferential surface of the extension portion 9 has a curved course, with the curve either extending outwards in a radial direction (convex) or inwards (concave).

In order to be able to exert a sufficiently high holding force on the connecting sleeve 1 during the pushing on of the first fluid line 2 (in particular during the widening of the first fluid line 2 by the extension portion 9), it may be advantageous if at least one holding groove 12 for receiving a suitable (not shown) holding tool is provided between the limiting portion, in particular the circumferential shoulder 10, and the second connecting-sleeve end 4, as shown in FIG. 1, FIG. 3 and FIG. 4. The retaining groove 12 may extend in the circumferential direction over a part of the circumference of the connecting sleeve 1, preferably around the entire circumference.

It may also be advantageous if the retaining groove 12 comprises at least one web 26 for retaining the retaining tool in a twistproof manner. In the example shown, for example, the retaining groove 12 is divided into two retaining grooves by two diametrically opposed webs 26. One of the two webs 26 is shown in FIG. 3. The webs 26 can prevent the connecting sleeve 1 from twisting while the first fluid line 2 is being pushed on. In addition, the webs 26 may be advantageous in order to give the connecting sleeve 1 greater rigidity.

It is also advantageous if a circumferential groove 7 is provided between the receiving portion 5 and the first connecting-sleeve end 3, in which a suitable gasket 15, preferably an O-ring or a moulded seal, can be arranged or is arranged. FIG. 1 shows the circumferential groove 7 without a gasket 15. The gasket 15 may be seen in FIG. 4 to FIG. 6. The extension portion 9 is preferably arranged between the centring portion 8 and the circumferential groove 7. The gasket 15 can be used to form a seal between the first fluid line 2 and the connecting sleeve 1. While an O-ring has an essentially circular cross section, a moulded seal may also have a different cross section, e.g. oval or angular. A moulded seal may also have one or more sealing lips on its circumferential surface.

Preferably, a length of the ferrule 13 is defined in such a way that the ferrule 13 not only surrounds the receiving portion 5, but also surrounds the circumferential groove 7 or, in particular, the gasket 15 arranged therein. This allows the gasket 15 to be protected from damage and contamination before the first fluid line 2 is installed.

When the first fluid line 2 is in the correct position (as shown in FIG. 5), the ferrule 13 can be plastically deformed in the radial direction using a suitable pressing tool (not shown in FIG. 5) in the region between two retaining protrusions 6, as viewed in the circumferential direction. For this purpose, the pressing tool may be used to exert a sufficiently high pressing force FP on the ferrule 13, as shown by the two arrows in FIG. 5. As a result, the first fluid line 2 can be fixed to the first connecting portion V1 in a twistproof manner.

FIG. 6 shows the connecting system with the first fluid line 2 connected. The ferrule 13 is shown in the deformed state, wherein the deformation regions 25 produced by the pressing tool are shown. As may be seen in FIG. 4 to FIG. 6, it may be advantageous if a diameter of the cylindrical receiving portion 5 (i.e. the regions between the retaining protrusions 6) is smaller than a maximum diameter of the extension portion 9 and/or a sealing portion at which the circumferential groove 7 is arranged. As a result, the first fluid line 2 can be held essentially in a positive locking manner in the axial direction by the portions that have been compressed by the ferrule 13 in the region of the deformation regions 25. The prerequisite for this is, of course, a sufficient deformability of the first fluid line 2, which is usually the case with a plastic pipe.

With reference to FIG. 7 and FIG. 8, a pressing tool 16 of an advantageous embodiment of the invention is described below. The pressing tool 16 is configured to carry out the connecting process described with the connecting system according to the invention. FIG. 7 shows the pressing tool 16 in a perspective view and FIG. 8 shows the pressing tool 16 in a sectional view.

The pressing tool 16 comprises a central arrangement space 17 for arranging the connecting system, i.e. the connecting sleeve 1 including the ferrule 13, as may be seen in FIG. 7. Furthermore, the pressing tool 16 comprises a plurality of pressing fingers 18, which are arranged in a circumferential direction around the arrangement space 17. The pressing fingers 18 are movable and can be moved in the direction of the arrangement space 17 (and in the opposite direction). The pressing fingers 18 are each configured to exert a pressing force FP in the radial direction on the ferrule 13 of the connecting sleeve 1 arranged in the arrangement space 17, as indicated in FIG. 8. As already mentioned, the ferrule 13 can be plastically deformed in portions by the pressing force FP in order to configure the

The number of pressing fingers 18 preferably corresponds to the number of retaining protrusions 6 of the connecting sleeve 1. This allows a simultaneous application of force between all retaining protrusions 6, whereby the ferrule 13 can be stressed relatively evenly in the circumferential direction. In the embodiment shown, the number of pressing fingers 18 comprises only four pressing fingers 18, by way of example. The pressing fingers 18 may be arranged at constant intervals around the circumference of the arrangement space 17. In principle, however, a smaller number of pressing fingers 18 could also be provided. In this case, the force could be applied sequentially. The connecting sleeve 1 could, for example, be twisted after each application of force of the number of pressing fingers 18 in order to bring the number of pressing fingers 18 into accordance to a portion of the ferrule 13 that has not yet been deformed.

According to an advantageous embodiment, the pressing tool 16 has a guide sleeve 19 which surrounds the arrangement space 17 in the circumferential direction. As may be seen in FIG. 8, the connecting system may be arranged in the arrangement space 17 such that the guide sleeve 19 surrounds the ferrule 13, which in turn surrounds the receiving portion 5 of the connecting sleeve 1. A guide recess 20 is arranged on the guide sleeve 19 for each pressing finger 18, which connects an outer circumferential surface of the guide sleeve 19 with an inner circumferential surface of the guide sleeve 19. The guide sleeve 19 is preferably dimensioned such that a distance between an inner circumferential surface of the guide sleeve 19 and an outer circumferential surface of the ferrule 13 is as small as possible. For example, the guide sleeve 19 may rest against the ferrule 13.

The guide recesses 20 are configured to guide the pressing fingers 18 in a radial direction. On the one hand, the guide sleeve 19 can prevent undesired deformation of the ferrule 13 during the connecting process, as the ferrule 13 is limited in the radial direction by the guide sleeve 19. This ensures that the material of the ferrule 13 does not evade during the application of force, so that the ferrule 13 cannot wrinkle. On the other hand, the pressing fingers 18 can be stabilised during movement by the guide sleeve 19.

As shown in FIG. 7, the pressing tool 16 may, for example, have a substantially cylindrical base body 23. A number of radially extending guide recesses may be provided on one (here upper) front side 23a of the base body 23, in each of which a guide block 24 is movably arranged. The pressing fingers 18 may be arranged at the ends of the guide blocks 24 that are on the inside in the radial direction. The pressing fingers 18 may, for example, be configured as separate components which can be attached to the guide block 24 in a suitable manner, e.g. screwed together. Of course, the pressing fingers 18 could also be configured integrally with the guide blocks 24, for example.

To carry out the connecting process, the connecting sleeve 1 (preferably including the pre-assembled ferrule 13 and possibly with the first fluid line 2 already attached-e.g. as shown in FIG. 5) may first be inserted with the second connecting-sleeve end 4 leading in an axial direction into the arrangement space 17 of the pressing tool 16. In the embodiment shown, the movement may take place in the direction of the front side 23a of the base body 23. During insertion, the free ends of the pressing fingers 18 are arranged preferably in a radial direction in a release position outside the arrangement space 17, for example in the region of the guide recesses 20 of the guide sleeve 19.

However, it would of course also be conceivable to first arrange only the connecting sleeve 1 (preferably including the pre-assembled ferrule 13) in the arrangement space 17 of the pressing tool 16, and only then could the first fluid line 2 be attached to the first connecting portion V1 of the connecting sleeve 1. In order to be able to exert a sufficiently large push-on force on the first fluid line 2, a suitable tool (not shown) may be provided.

The connecting sleeve 1 may be positioned in the axial direction relative to the pressing tool 16 so that the ferrule 13 is arranged in the region of the pressing fingers 18. A correct positioning in the axial direction may be ensured, for example, by a suitable, preferably adjustable, stop (not shown).

Furthermore, the connecting sleeve 1 may be aligned in the circumferential direction relative to the pressing tool 16 such that the available pressing fingers 18 are each arranged between two retaining protrusions 6 of the connecting sleeve 1. A correct alignment may be achieved, for example, using a suitable positioning device (not shown). The positioning device may, for example, have an optical marking on the pressing tool 16, which can be matched with a marking or feature of the connecting sleeve 1. However, the positioning device could also be configured mechanically, for example, in that a positioning protrusion of the connecting sleeve 1 engages with a positioning recess of the pressing tool 16. However, the positioning device could also have a suitable sensor system, for example.

The pressing tool 16 may further comprise a suitable force generation device 21 for generating the pressing force FP and a control unit 22 for controlling the force generation device 21. The force generation device 21 and the control unit 22 are only symbolically indicated in FIG. 7 and may be configured in a suitable manner. The force generation device 21 may, for example, comprise a number of suitable electrically controllable actuators, e.g.

hydraulic cylinders, pneumatic cylinders or the like. The control unit 22 may comprise suitable hardware and/or software.

Furthermore, one or more suitable sensors could be provided for detecting a measured variable of the connecting process, which can communicate with the control unit 22. It would be conceivable, for example, that a position or displacement sensor is provided for one or more pressing fingers 18 to detect a radial movement. Alternatively or additionally, for example, a suitable force sensor could also be provided to detect the pressing force FP. The control unit 22 can use the recorded measured values to control the connecting process. For example, the connecting process may be terminated when a predetermined pressing force FP or a predetermined position of the pressing fingers 18 is reached. A suitable sensor system, e.g. for angle measurement, may also be provided in order to ensure a correct position of the connecting sleeve 1 in the circumferential direction relative to the pressing tool 16.

The exemplary embodiments show possible embodiment variants, wherein it should be noted at this point that the invention is not limited to the specifically illustrated embodiment variants thereof, but rather various combinations of the individual embodiment variants with one another are also possible and this variation possibility lies within the ability of the skilled person working in this technical field due to the teaching on technical action by the present invention.

The scope of protection is determined by the claims. However, the description and the drawings should be consulted to interpret the claims. Individual features or combinations of features from the various exemplary embodiments shown and described may constitute inventive solutions in their own right. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE SIGNS

1 connecting sleeve 26 web
2 first fluid line V1 first connecting portion
3 first connecting-sleeve end V2 second connecting portion
4 second connecting-sleeve end FP pressing force
5 receiving portion AR receiving space
6 retaining protrusion
6a contact surface
7 circumferential groove
8 centring portion
9 extension portion
10 circumferential shoulder
10a first end face
10b second end face
11 fixing recess
12 holding groove
13 ferrule
14 fixing lug
15 gasket
16 pressing tool
17 arrangement room
18 pressing finger
19 guide sleeve
20 guide recess
21 force generation device
22 control unit
23 base body
23a front side
24 guide block
25 deformation region

1. A connecting system for connecting a first fluid line (2) to a second fluid line, wherein the connecting system has a connecting sleeve (1) with an open first connecting-sleeve end (3) and an open second connecting sleeve-end (4) connected to the first connecting-sleeve end (3), wherein a first connecting portion (V1) is provided on the connecting sleeve (1), onto which the first fluid line (2) can be pushed in order to connect the first fluid line (2) to the first connecting-sleeve end (3) of the connecting-sleeve (1), and wherein the second connecting-sleeve end (4) comprises a second connecting portion (V2) for connecting to the second fluid line, wherein the first connecting portion (V1) of the connecting sleeve (1) comprises a cylindrical receiving portion (5), wherein a plurality of retaining protrusions (6) that are spaced apart in the circumferential direction and each extend at least along a part of a length of the receiving portion (5) are provided on an outer circumferential surface of the receiving portion (5), and wherein the connecting system comprises a ferrule (13), wherein the ferrule (13) can be arranged on the connecting sleeve (1) such that the ferrule (13) surrounds the receiving portion (5) and such that, in a radial direction between the receiving portion (5) and an inner circumferential surface of the ferrule (13), a receiving space (AR) for receiving an end portion of the first fluid line (2) is formed, wherein the ferrule (13) is configured to be plastically deformed in the circumferential direction in the region between two retaining protrusions (6) by a pressing tool (16) in the radial direction in order to fix the first fluid line (2) to the first connecting portion (V1) in a twistproof manner.

2. The connecting system according to claim 1, wherein at least one of the retaining protrusions (6) of the connecting sleeve (1) has an elongated configuration and extends over at least half the length of the receiving portion (5).

3. The connecting system according to claim 1, wherein the plurality of retaining protrusions (6) comprises at least two, preferably at least four, particularly preferably at least six retaining protrusions (6).

4. The connecting system according to claim 1, wherein the retaining protrusions (6) are arranged evenly distributed on the receiving portion (5) in the circumferential direction.

5. The connecting system according to claim 1, wherein a circumferential groove (7) is provided between the receiving portion (5) and the first connecting-sleeve end (3) of the connecting sleeve (1), in which a gasket (15), preferably an O-ring or a molded seal, can be arranged or is arranged.

6. The connecting system according to claim 1, wherein a centering portion (8) for centering the first fluid line (2) is provided at the first connecting-sleeve end (3) of the connecting sleeve (1).

7. The connecting system according to claim 1, wherein between the receiving portion (5) and the first connecting-sleeve end (3) of the connecting sleeve (1) an extension portion (9), preferably conical or curved, is provided which tapers in the direction of the first connecting-sleeve end (3), wherein the extension portion (9) is preferably arranged between the centering portion (8) and the circumferential groove (7).

8. The connecting system according to claim 1, wherein the connecting sleeve (1) is made of a plastic and wherein the retaining protrusions (6) are configured integrally with the connecting sleeve (1).

9. The connecting system according to claim 1, wherein a limiting portion is provided between the receiving portion (5) and the second connecting-sleeve end (4) of the connecting sleeve (1), which forms a stop for the first fluid line (2).

10. The connecting system according to claim 9, wherein the limiting portion comprises a circumferential shoulder (10) with a first end face (10a) facing the first connecting-sleeve end (3) and an opposite second end face (10b) facing the second connecting-sleeve end (4), wherein the retaining protrusions (6) are preferably connected to the circumferential shoulder (10).

11. The connecting system according to claim 10, wherein the circumferential shoulder (10) comprises at least one fixing recess (11) which extends in the circumferential direction over a part of the circumferential shoulder (10), connects the first end face (10a) to the second end face (10b) and is preferably open to the outside in the radial direction, and wherein the ferrule (13) has at least one fixing lug (14) at a ferrule end (13a) facing the second connecting-sleeve end (4), which, in the assembled state, extends through the at least one fixing recess (11) of the circumferential shoulder (10) in the direction of the second connecting-sleeve end (4) and bears against the second end face (10b) of the circumferential shoulder (10).

12. The connecting system according to claim 9, wherein a retaining groove (12) for receiving a retaining tool is provided between the limiting portion, in particular the circumferential shoulder (10), and the second connecting-sleeve end (4).

13. The connecting system according to claim 12, wherein the retaining groove (12) comprises at least one web (26) for receiving the retaining tool in a twistproof manner.

14. The connecting system according to claim 1, wherein the ferrule (13) is made of a metallic material, preferably aluminum.

15. A use of a connecting system according to claim 1, wherein a first fluid line (2), preferably a plastic pipe, is pushed onto the first connecting portion (V1) of the connecting sleeve (1), until an end portion of the first fluid line (2) is arranged in the receiving space (AR) and wherein the ferrule (13) is plastically deformed in the circumferential direction in each case in the region between two retaining protrusions (6) by a pressing tool (16) in the radial direction in order to fix the first fluid line (2) to the first connecting portion (V1) of the connecting sleeve (1) in a twistproof manner.

16. A pressing tool (16) for carrying out a connecting process with the connecting system according to claim 1, wherein the pressing tool (16) comprises an arrangement space (17) for arranging the connecting system, wherein the pressing tool (16) has a plurality of pressing fingers (18) which are arranged distributed in a circumferential direction around the arrangement space (17), and wherein the pressing fingers (18) are each configured to be moved in the direction of the arrangement space (17) and to exert a pressing force (FP) in the radial direction on the ferrule (13) of the connecting system arranged in the arrangement space (AR), by which the ferrule (13) can be plastically deformed in portions in the circumferential direction.

17. The pressing tool (16) according to claim 16, wherein the pressing tool (16) comprises a guide sleeve (19) which surrounds the arrangement space (17) in the circumferential direction, wherein the guide sleeve (19) is arranged such that the guide sleeve (19) surrounds the ferrule (13) of a connecting sleeve (1) arranged in the arrangement space (17), wherein a guide recess (20) for guiding the respective pressing finger (18) is provided on the guide sleeve (19) for each pressing finger (18).

18. The pressing tool (16) according to claim 16, wherein the pressing tool (16) comprises a force generation device (21) for generating the pressing force (FP) and a control unit (22) for controlling the force generation device (21).
